(19) United States
(12) Patent Application Publication
(10) Pub. No.: US 2024/0327938 A1
(43) Pub. Date: Oct. 3, 2024

(54) METHOD FOR IF-INTERSTITIAL FREE STEEL PRODUCTION USING SCRAP IN ARC FURNACE FACILITIES

(71) Applicant: ÇOLAKOGLU METALURJI ANONIM SIRKETI, Istanbul (TR)

(72) Inventors: Murat GUNERDI, Istanbul (TR); Talip KUCUK, Istanbul (TR); Burhan Burc GUNDOGAN, Istanbul (TR); Mehmet Dincer DEMIRCIOGLU, Istanbul (TR)

(21) Appl. No.: 18/571,947

(22) PCT Filed: Oct. 10, 2021
(86) PCT No.: PCT/TR2021/051031

§ 371 Date: Dec. 19, 2023

(51) Int. Cl. C21C 5/52; C21C 7/00; C21C 7/06; C21C 7/064; C21C 7/068; C21C 7/10; C22C 38/00; C22C 38/02; C22C 38/04; C22C 38/06; C22C 38/14; C22C 38/16

(52) U.S. Cl. CPC C21C 5/52; C21C 7/0006; C21C 7/06; C21C 7/064; C21C 7/068; C21C 7/10; C22C 38/001; C22C 38/002; C22C 38/004; C22C 38/02; C22C 38/04; C22C 38/06; C22C 38/14; C22C 38/16

(57) ABSTRACT

The invention relates to interstitial free (IF) steel production using scrap and its production method.

In particular, the invention relates to IF steel with improved formability and strength properties and its production method, which is produced using scrap to eliminate the dependence on raw iron ore in IF steel production by using recyclable and reusable resources.

The present invention relates to IF steel and its production method, which is produced using 50-100% scrap, which eliminates dependence on raw iron ore in IF steel production by utilizing recyclable, reusable resources.

### TECHNICAL FIELD OF THE INVENTION

The invention relates to interstitial (IF) steel produced using scrap and its production method.

In particular, the invention relates to IF steel with improved formability and strength properties and its production method, which is produced using scrap to eliminate the dependence on raw iron ore in IF steel production by using recyclable and reusable resources.

### STATE OF THE ART

Interstitial free (IF) steel or IF steel is a type of steel developed to stretch solid iron lattice, obtained by ensuring the absence of atoms in the interstitial positions (interstitial spaces). Unlike conventional steels, interstitial free (IF) steels are obtained by reducing the interstitial elements such as carbon (C), oxygen (O), and nitrogen (N) dissolved between iron atoms to the lowest possible levels.

Conventional IF steels, developed commercially with the introduction of vacuum degassing technology in Japan in the 1970s, contained carbon (C) in the 40-70 ppm range and nitrogen (N) in the 30-50 ppm range. Niobium (Nb) and/or titanium (Ti) were then added to these steels to stabilize the interstitial carbon (C) and nitrogen (N) atoms.

This low-carbon steel type, which has good deep drawing properties and no interstitial atoms in its crystal lattices developed by Japanese steel manufacturers, has been developed by using modern production techniques, and it is suitable for formatting, especially when its carbon (C) and nitrogen (N) atom ratios are under <0.0050% C and 0.0050%. N. In Table 1 below, the percent contents of an interstitial free (IF) steel are given in today's conditions.

TABLE 1
IF Steel content percentage analysis without interstitial atom - IF Steel grade 71114

| % C | % Mn | % Si | % P | % S | % Al | % N | % O | % Ti | % Cu |
|---|---|---|---|---|---|---|---|---|---|
| 0.0050 | 0.05- | 0.003 | <0.0150 | <0.0060 | 0.040- | 0.0050 | 0.0002 | 0.060- | 0.06 |
| max. | 0.10 | max. | | | 0.070 | max. | max. | 0.080 | max. |

IF steels have a free body-centered cubic (bee) ferrite matrix, high plastic strain rate (r-value), high strain rate sensitivity, and good formability. At the same time, IF steels show low yield strength and high resistance to thinning. In addition to all these features, IF steels, which have excellent formability thanks to the micro-alloy elements it contains, have become essential for manufacturers in the automobile and white goods sectors. Generally, 50% of the IF steels produced are used in the automobile sector, 16% in the electronics sector, 7% in the white goods sector, and 27% in different sectors. Therefore, the demand for IF steel production is increasing day by day.

In state-of-the-art, IF steels are produced from ore in blast furnaces or 100% hot sponge iron (Hot DRI) in Arc Furnaces. Conventionally, IF steels produced from ore are produced in Iron-Steel plants growing from ore. In these plants, the liquid raw iron from the blast furnaces is subjected to desulphurization (DeS) before the converter (Simple Oxygen Furnace-BOF) process. In the desulphurization process, sulfur (S) is reduced from a level of 0.0800% to a level of 0.0050%. If necessary, liquid raw iron with reduced sulfur content is taken to the converter (Simple Oxygen Furnace-BOF) facility and converted into steel using the oxygen blowing method.

The analysis of the liquid steel obtained after the converter process is as shown in Table 2 below.

TABLE 2
Percentage analysis of conventional liquid steel content

| % C | % Mn | % Si | % P | % S | % Al | % N | % O | % Ti | % Cu |
|---|---|---|---|---|---|---|---|---|---|
| 0.03- | 0.03- | <0.003 | <0.0050 | <0.0050 | <0.0030 | <0.0050 | 0.0600- | <0.0010 | 0.03 |
| 0.05 | 0.05 | | | | | | 0.0800 | | max. |

In conventional production, very little denitrification is carried out in RH-type vacuum plants. Because when liquid steel is obtained from ore and/or its derivative, naturally, the nitrogen value is lower than the desired standard. As can be seen in Table 2, the steels produced in this way have less input in terms of sulfur (S) and copper (Cu), and nitrogen (N) and are therefore more efficient. Following the converter facility for IF production from a steel of this quality, it is sent to the RH-OB (TheRuhrstahlHeraeus-OxygenBlowing) facility for decarburization, deoxidation, and alloying. However, raw iron or hot sponge iron obtained from the ore used for IF steel production in conventional methods is limited in terms of raw materials, no matter what kind of processing is performed.

Iron ore reserves in the world are known to be 167 billion tons. Most of these reserves are located in Australia. Brazil, Canada, India, the USA, South Africa, Liberia. Sweden, Peru, China, and Russia. In Turkey, the reserves are concentrated in Sivas, Malatya, Bingöl, Adana and Kayseri regions. According to the feasibility report prepared by the General Directorate of Mineral Research and Exploration titled “Iron in the World and Turkey,” these known iron ore reserves in Turkey are not in a position to meet the needs of integrated iron and steel factories for a long time with the current consumption level.

In iron ore mining in our country, iron ore imports will continue to increase over the years if there are no new deposits, reserves related to existing deposits are not developed, their quality is not improved, and production costs are not reduced. It is expected that approximately 124.6 million tons of workable iron reserves will be depleted at the end of 21 years with an annual average production of 6-8 million tons and complete dependence on imports to meet the annual average of 15-18 million tons of iron ore need will arise. For this reason, it is of great importance to find alternative solutions instead of raw iron input obtained from ore to meet the demand for IF steel produced for use in various sectors.

It is currently desired to produce IF steel from scrap as raw material instead of ore. However, compared to the conventional methods, when IF steel is produced from waste, additional processing steps and treatments are needed, mainly when producing high-quality IF steel at the desired standard.

In the state of the art, the patent document with number “CN105861929B” describes a kind of IF steel and its production method, more specifically, IF steel and its production method, with cold rolling at the level of 440 MPa. This cold rolled high strength IF Steel has 0.0015%˜0.0035% C; 0.40%˜0.50% Si; 0.75%˜0.95% Mn; 0.08%˜0.10% P; 0.02%˜0.03% Nb; 0.018%˜0.035% Ti chemical components and percentages.

According to this production method, after desulfurizing the iron first, it is subjected to a high melting process to besmerize 0.040˜0.080% by weight of the high phosphorus molten steel obtained. Next, the hot rolling slab tapping temperature, where the soaking time is ≥180 minutes, and the winding temperature is 700˜725° C. after final rolling, is divided by the thickness specification and rolled with a cold rolling reduction ratio of 60-75% at a continuous annealing soaking temperature of 810˜830° C. Finally, it is exposed to a slow cooling temperature of 640˜660° C. and an aging temperature of 350˜380° C.

In state of the art, another kind of IF steel and production methods are explained in another patent document numbered “CN108203789B”. According to this document. IF steels have the specified percentages of elements as iron (Fe) and 0<C≤0.009%, 0<Si≤0.0%, Mn:% 0.2-0.8%, P:% 0.02-0.08%, Nb:% 0.005-0.025%, Ti:% 0.005%-0.025, B:% 0.0001-0.001%, Al:% 0.01-0.09%, N≤% 0.005%, S:% 0.015% have the specified percentages of elements. IF steels' production method with specified content also includes the processing steps of melting and castings, hot rolling, and annealing. In the annealing process step, the steel plate is heated to the guarantor of 700-900° C., then the temperature is cooled to 600-750° C. in 10-35 s, the control annealing speed that enables the annealing furnace to be controlled is 100-350 m/s, and finally, the dew point of the atmosphere point is −30˜0° C. The surface potential of the IF steel, having a corrosion resistance feature, obtained in this way was measured to be ≥−410 mV, with a tensile strength of ≥360 MPa.

However, none of these methods describes a method in which purely, i.e., 50 to 100% scrap, is used as the raw material and the IF steel obtained is of high quality, for example, IF steel of grade 71114. There is no explanation for the use of scrap in these two documents explaining raw iron as raw material.

Moreover, due to the difficulties and inadequacies of failing to have new ore deposits, to develop reserves related to existing deposits, to increase quality, to reduce production costs, and therefore becoming utterly dependent on imports to meet the iron ore need, it has been necessary to make a development in the relevant technical field.

Conventionally, steels in IF steel quality are produced in Iron-Steel plants that grow from ore. However, since the raw material is taken from the ore in this method, the copper (Cu) and Nitrogen (N) content is less in this type of production and requires less additional processing.

Therefore, a method is needed in the current art, where the raw material contains most scrap, for example, 50 to 100%, that enables high-quality IF steel production.

The subject invention relates to high-quality IF steel, which is produced using scrap to make use of recyclable and reusable resources. The disadvantage of being completely dependent on iron ore and thus imports in IF steel production is eliminated, and its production is eliminated method.

### DETAILED DESCRIPTION OF THE INVENTION

The present invention relates to IF steel, which is produced using 50-100% scrap, and its production method, which eliminates dependence on raw iron ore in IF steel production by utilizing recyclable, reusable resources.

The method in question includes melting the scrap to be used, ladle furnace operations, slag filtering operations, vacuum operations, and casting operations.

Accordingly, the present invention relates to an interstitial free (IF) steel production method using scrap as raw material, and the said method includes the following process steps.
i. Removing the charge of the melted scrap in such a way that the copper (Cu) ratio by weight is a maximum of 0.06%.
ii. melting the scrap whose charge is removed in the arc furnace,
iii. Deoxidation of the liquid steel obtained after melting with a suitable element in the ladle furnace,
iv. desulphurizing the deoxidized liquid steel in the ladle furnace
v. adding alloying elements to liquid steel,
vi. draining the slag on the liquid steel surface with a slag drawing machine,
vii. Taking the slag filtered liquid steel into a vacuum facility and mixing inert gas with the liquid steel to achieve nitrogen (N) removal (Denitrification) by deep vacuum degassing (VD),
viii. blowing oxygen under high flow to molten steel to reduce the carbon (C) level by means of the vacuum oxygen decarburization (VOD) process under vacuum in the vacuum plant,
ix. Natural decarburization under vacuum,
x. Adding a slag-forming material under vacuum and a suitable element for re-deoxidation to improve slag conditions and reduce the oxygen value,
xi. Deoxidation and addition of alloying elements,
xii. Sending the liquid steel to the continuous casting machine to turn it into a semi-finished product through target analysis verification.

The inventors have determined that the scrap's Copper (Cu) content is significant for producing high-quality IF steel in an IF steel production method in which scrap is used as a raw material.

As a matter of fact, since liquid steel obtained from ore and/or its derivatives is used as an iron source in conventional production, no additional treatment is required in terms of copper content. However, in a production method in which scrap is used as raw material, copper content becomes essential, mainly when it is aimed to obtain high-quality IF steel. In this respect, the inventors in their studies show that the IF steel obtained as a result of the steel production method is surprising of the desired quality if the copper ratio of the scrap mixture is a maximum of 0.06% by weight for the production of high quality IF steel. Therefore the method was more efficient and be successful.

The scrap mix to be used in the method according to the invention contains various scrap types.

The content of the raw material to be used for the production of high-quality IF steel is crucial. The use of scrap without suitable content causes the emergence of unwanted by-products during the production method steps or the requirement to have additional processes to remove these by-products. As a result, both the cost of the production method increases, and there is a further loss because the production method requires a longer time.

For this reason, the scrap to be used as raw material in the high-quality IF steel production method, which is the subject of the invention, contains certain scrap types and contains these scrap types in specific proportions.

Said scrap contains various scrap types such as domestic, DKP, USA HMS, European HMS, Black Sea HMS, Package HMS, Pig, HBI, Busheling, Package Busheling, chopped, chopped low copper. Said scrap may contain one or more of these scrap types together with others in a mixture.

In a preferred embodiment of the invention, the scrap to be used in the IF steel production method according to the invention contains 30 to 100% by weight of a scrap mixture and 0 to 70% of Pig iron and HBI (hot briquetted iron) mixture.

In a particularly preferred embodiment of the invention, the scrap used contains 50 to 100% of a scrap mixture and 0 to 50% of Pig Iron-HBI mixture by weight.

In another embodiment of the invention, the scrap to be melted in the IF steel production method according to the invention contains 5 to 40% DKP, 15 to 35% Pig, 0 to 50% HBI, 5 to 50% Busheling, 1 to 40% Package Busheling.

In a particularly preferred embodiment of the invention, the scrap to be melted contains 10 to 35% DKP, 20 to 30% Pig, 20 to 30% HBI, 15 to 40% Busheling, 2 to 35% Package Busheling by weight.

In an alternative embodiment of the invention, the scrap mixture does not contain HBI.

Accordingly, in an alternative embodiment of the invention, the scrap mixture to be melted contains 10 to 35% DKP, 20 to 30% Pig, 15 to 40% Busheling, 2 to 35% Package Busheling by weight.

In the high-quality IF steel production method, which is the subject of the invention, liquid steel is obtained after melting, and ladle furnace processes must be applied to the obtained liquid steel. These processes are deoxidation, desulphurization, and alloying processes, respectively.

Elements with a high affinity for oxygen are preferred in the deoxidation process. These can be elements such as Al, Si, and Ti.

According to the invention, the element Al can preferably be used in the deoxidation step in the method.

With the said deoxidation step, the [O] value in the liquid steel can be reduced from 0.0600-0.0800% to below <0.0003.

During deoxidation, the following reaction takes place.

2Al+3/2[O]→(Al₂O₃)ₛ

The molten steel must be treated under certain conditions before desulphurization to achieve a successful desulphurization process. Otherwise, after the ladle furnace operations are completed, the desired success will not be achieved in the slag removal process, either.

For this purpose, surprisingly, it is essential to keep the liquid steel in the following conditions before the desulphurization step for the high quality IF steel production method, which is the subject of the invention, to provide a successful and efficient product.
A. Oxygen (O) ratio less than 0.0005% by weight
B. CaO/SiO₂ weight ratio greater than 2.5 to ensure alkalinity of slag
C. Inert gas mixing speed is 1000 Nl/min (Normal liter/minute)

Accordingly, another feature of the high quality IF steel production method, which is the subject of the invention, is that the liquid steel is present under the following conditions before the desulphurization step (step iv) performed during the ladle furnace operations:
A. Oxygen [O] ratio is less than 0.0005% by weight.
B. A weight ratio of CaO/SiO2 greater than 2.5 to ensure alkalinity of the slag,
C. Inert gas mixing rate is 1000 Nl/min of

Condition A. mentioned above is obtained as a result of the deoxidation step.

At this stage, the liquid steel contains slag. Slag-forming material is added to the liquid steel to ensure the alkalinity of the slag. The slag-forming material is added until the ratio of slag-forming material to SiO₂ in the liquid steel is 2.5. In this way, condition B is fulfilled.

At the same time, inert gas is mixed in the liquid steel, and it has been determined that the required inert gas mixing speed should be 1000 NI/min per minute for the sulfur to be successfully removed from the liquid steel and passed into the slag phase. With this mixing, condition C. is also met.

Following the invention method, the inert gas supplied to the liquid steel in the VOD plant to remove sulfur before desulphurization is Argon (Ar).

Therefore, due to a desulphurization process where the above conditions A., B. and C. are met, the sulfur in the liquid steel is successfully removed and brought to the slag phase. The reaction taking place in this step is given below.

3(CaO)+3[S]+2[Al]→3(CaS)ₛ+(Al₂O₃)ₛ

The slag-forming material to be used in the IF steel production method, which is the subject of the invention, can be selected among lime, materials containing calcium oxide (CaO), materials containing aluminum oxide (Al₂O₃). materials containing silicon dioxide (SiO₂), aluminum slag and/or calcium fluoride (CaF₂).

In one embodiment of the invention, the slag-forming material used in the high-quality IF steel production method is preferably CaO.

After the desulphurization process, the ladle furnace operations are completed when the sulfur value in the liquid steel drops below the Sulfur (S)<% 0.0030.

All of the slag formed on the liquid steel surface as a result of the ladle furnace operations is filtered by a slag drawing machine. Complete filtration of the slag is very important for the success of the processes to be carried out under a vacuum.

Saturation of sulfur content was achieved in the slag made in the ladle furnace. And in further processes, the sulfur reaction always wants to be in balance

If it is exposed to reoxidation by an outside intervention

3(CaO)+3[S]+2[Al]→3(CaS)ₛ+(Al₂O₃)ₛ

The reaction will run to the left

(CaS)+O_{g}→(CaO)ₛ+[S]ₛ

In the alloying step of ladle furnace processes. manganese (Mn), silicon (Si), aluminum (Al) elements are added to the liquid steel to increase elements such as manganese (Mn), silicon (Si), aluminum (Al).

In such an intervention, the sulfur amount in the steel bath will increase with the amount coming from the slag. All the slag on the liquid steel must be removed to prevent this. In this respect, in the method subject to the invention, after the completion of the processes under the ladle furnace, at least 95%, preferably 98%, especially preferably 99.8% by weight of the slag formed on the surface of the liquid steel is drained by the slag machine.

After slag leaching is complete and the liquid steel is processed in a vacuum plant.

In the VOD facility, under vacuum pressure, it is aimed to take oxygen, hydrogen gases, especially nitrogen gas, in the steel bath with inert gas in the denitrification step.

The partial pressures and volumes of such gases in the steel are very low in the atmospheric environment (˜1000 mbar). Inert gases cannot keep these gases in gas bubbles under atmospheric pressure.

In this respect, it has been determined that denitrification must be carried out under deep vacuum conditions, that is, under pressure below 1 mbar, for the high quality IF steel production, which is the subject of the invention be productive at the desired rate.

In this respect, a feature of the high-quality IF steel production method, which is the subject of the invention, is that the denitrification in step (iv) is realized below 1 mbar pressure.

In a preferred embodiment of the invention, denitrification is done between 0.5 mbar and 0.9 mbar.

In a particularly preferred embodiment of the invention, denitrification is done under 0.8 mbar.

In a particularly preferred embodiment of the invention, argon is the inert gas used in the denitrification step.

In another embodiment of the invention, the inert gas mixed in the denitrification process is between 0.08 and 0.20 m³ (0.08 to 0.20 m³/Tons of Steel) per Ton of Steel.

In a preferred embodiment of the invention, the inert gas mixed in the denitrification process is between 0.10 and 0.15 m³ (0.10 to 0.15 m³/Tons of Steel) per Ton of Steel.

In a particularly preferred embodiment of the invention, the inert gas mixed in the denitrification process is 0.08 m³ (0.08 m³/Tons of Steel) per Ton of Steel.

For natural decarburization under vacuum after denitrification, oxygen is blown into the liquid steel under high flow to reduce the carbon (C) level.

The decarburization process lowers the C value in the liquid steel bath and is illustrated by the following chemical reaction.

[C]+O_{(g)}→CO_{(g)}

It has been determined that the oxygen used should be under high pressure to increase the penetration of carbon into the liquid steel and provide high penetration. In this respect, the inventors have found in their studies that the desired decarburization will not be achieved and the expected low carbon level cannot be achieved if oxygen is not blown at a certain pressure and speed.

In this respect. another feature of the high-quality IF steel production method, which is the subject of the invention, is vii. The oxygen blowing in the step is to be carried out under at least 8 bars pressure.

In oxygen blowing, the speed of the oxygen should be at the desired speed as stated. Otherwise, a high oxidizing environment cannot be achieved at the desired rate. At lower flow values, VOD pumps and injectors attract oxygen gas and prevent the formation of an oxidizing environment.

Accordingly, another feature of the high quality IF steel production method, which is the subject of the invention, is that in step (vii) oxygen blowing is carried out under a high flow rate, preferably at 1 to 5 m³/Tons of Steel, more preferably 2 to 3 m³/Tons of Steel, especially preferably 2.5 m³/Tons of Steel.

In an alternative embodiment of the invention, the high-quality IF steel production method is preferably carried out under a pressure of 8 to 10 bar and at a volume of 1 to 5 m3/Tons of Steel.

The amount of oxygen blowing depends on the analysis at the input conditions. The person skilled in the art will find the oxygen requirement of the metallic materials to be oxidized in the input analysis based on stoichiometric calculations.

The following descriptions are made to exemplify the IF steel production method according to the invention and are in no way limiting the scope of the invention.

### Example 1

The scrap mixture to be taken to the electric arc furnace is prepared according to the following recipe.

Scrap Mixture Prepared with Pig - HBI

| | | | | Package | Total |
|---|---|---|---|---|---|
| DKP (t) | Pig (t) | HBI (t) | Busheling (t) | Busheling | Scrap (t) |
| 29% | 22% | 27% | 18% | 4% | 100% |

The scrap mixture is melted in the arc furnace and liquid steel is obtained.

The liquid steel obtained after melting is transferred to an empty crucible without a rim and analyzed. The values obtained as a result of the analysis are given in the table below.

TABLE 3
The result of the liquid steel analysis that is obtained
as a result of melting the scrap whose charge was removed

| % C | % Mn | % Si | % P | % S | % Al | % N | % O | % Ti | % Cu |
|---|---|---|---|---|---|---|---|---|---|
| 0.03- | 0.03- | <0.002 | <0.0050 | 0.0450- | <0.0030 | >0.0060 | 0.0600- | <0.0010 | 0.06 |
| 0.05 | 0.05 | | | 0.0550 | | | 0.0800 | | max. |

In the next step, the liquid steel is subjected to deoxidation, desulphurization and alloying processes. respectively. For the deoxidation process, aluminum is charged into the liquid steel bath. The amount of aluminum is adjusted according to the amount of liquid steel in the ladle furnace. The deoxidation process is continued until the [O] in the liquid steel drops from 0.0600-0.0800% to at least 0.0005%. Here, the amount of aluminum adjustment according to the amount of liquid steel in the ladle furnace is made so that 3-5 kg of aluminum is charged per ton of liquid steel.

After the deoxidation process is completed, the slag sample is taken and the CaO/SiO₂ weight ratio is checked, and this ratio is adjusted to be greater than 2.5.

Inert gas was mixed into the liquid steel at a rate of 1000 Nl/min.

When these conditions are achieved, the desulphurization process is started and the process is continued until the Sulfur (S)<0.0030% value is reached.

Deoxidation and desulphurization processes carried out in the ladle furnace are completed in the ladle furnace. The liquid steel is analyzed and the values given in the table below are obtained as a result of the analysis.

TABLE 4
Ladle furnace content analysis after deoxidation and desulphurization

| % C | % Mn | % Si | % P | % S | % Al | % N | % O | % Ti | % Cu |
|---|---|---|---|---|---|---|---|---|---|
| 0.06 | 0.10 | 0.03 | 0.0050 | 0.0030 | 0.0450 | 0.0080 | 0.0003 | 0.0050 | 0.06 |
| max. | max. | max. | max. | max. | max. | min. | max. | max. | max. |

For the slag drawing process, the slag on the surface of the liquid steel was filtered by a slag drawing machine. After the slag was completely filtered, the liquid steel was taken to the liquid steel vacuum plant for nitrogen removal and decarbonization steps.

Liquid steel with low oxygen and sulfur content is processed under a deep vacuum of less than 1 mm bar, for example 0.8 mm bar. In the denitrification step, inert gas was mixed with the liquid steel at the rate of 0.12 m3/Tons of steel under deep vacuum conditions, and the nitrogen level was reduced below 0.0040%.

After this process, the facility was placed in the VOD position, and oxygen was blown to reduce the carbon level. For decarburization, natural decarburization was carried out under vacuum with oxygen blowing at a pressure higher than 8 bar, approximately 2.5 m³/Tons of Steel, under high flow, and the carbon value of the liquid steel reached below the level of 0.0035%.

To improve the slag conditions and reduce the oxygen value, slag-forming material (CaO) is added under vacuum, and Aluminum is added for deoxidation. The amount of these materials is adjusted according to the amount of liquid steel.

After oxygen blowing, the dissolved oxygen value in the liquid steel reaches the order of 0.0500%, so the deoxidation process is carried out after oxygen blowing.

After these processes are completed under vacuum, the tank is carefully transferred to atmospheric conditions, and the addition of inert gas is terminated.

Alloy materials to be added after the samples taken are made by wire injection. These added alloy materials can be iron-titanium (FeTi) wire and/or Aluminum wire. With the target analysis verification, the liquid steel is sent to the continuous casting machine. The values obtained as a result of the analysis are given in the table below.

TABLE 5
VD/VOD analysis

| % C | % Mn | % Si | % P | % S | % Al | % N | % O | % Ti | % Cu |
|---|---|---|---|---|---|---|---|---|---|
| 0.0040 | 0.10 | 0.03 | 0.0050 | 0.0030 | 0.040- | 0.0040 | 0.0002 | 0.060- | 0.06 |
| max. | max. | max. | max. | max. | 0.060 | max. | max. | 0.080 | max. |

A high-quality IF steel can be obtained with the production method of the invention. Said high quality IF steel can be defined by the elements it contains and their ratios.

Accordingly, the high quality IF steel obtained by the production method of the invention can be an IF steel with preferably a maximum of 0.0040% by weight of carbon (C), a maximum of 0.10% by weight of manganese (Mn), a maximum of 0.03% by weight of silicon (Si), maximum 0.0050% by weight of phosphorus (P), maximum 0.0030% of sulfur by weight, 0.040% to 0.060% by weight of aluminum (Al), maximum 0.0040% of nitrogen (N) by weight, oxygen (O) by weight, a maximum of 0.0002% by weight titanium (Ti), a maximum copper (Cu) ratio of 0.06% by weight.

Said IF steel can be used in the automotive, white goods, and electronic goods sectors.

As can be understood from the explanations above, there are essential differences between the familiar IF steel production methods and the production method subject to the present invention. Since the production method that is the subject of the invention starts with 100% scrap as raw material, conventional production methods are insufficient or unsuitable for using scrap as raw material.

The production method, which is the subject of the invention, has many critical features such as the copper ratio in the scrap used and the unique scrap mixture, providing the desired conditions for the sulphurization and denitrification processes, carrying out the oxygen blowing under certain conditions, sensitively removing the slag before the operations in the tank-type vacuum plant, and these conditions completely different from the requirements of conventional production methods. However, the inventive production method with these critical properties provides the desired quality of IF steel.

1. An interstitial free (IF) steel production method where scrap is used as raw material, comprising the following steps:
i. Removing the charge of the scrap to be melted in such a way that the copper (Cu) rate of the scrap to be melted is a maximum of 0.06% by weight,
ii. melting the scrap whose charge is removed in the arc furnace,
iii. deoxidation of the liquid steel obtained after melting with a suitable element in the ladle furnace,
iv. desulphurizing the deoxidized liquid steel in the ladle furnace,
v. Adding alloying elements to liquid steel,
vi. draining the slag on the liquid steel surface with a slag drawing machine,
vii. Taking the slag filtered liquid steel into a vacuum facility and mixing inert gas into the liquid steel to achieve nitrogen (N) removal (DeN) by deep vacuum degassing (VD),
viii. blowing oxygen into liquid steel under high flow to reduce the carbon (C) level by means of the oxygen decarburization (VOD) process under vacuum in the vacuum plant,
ix. Natural decarburization under vacuum,
x. Adding a slag-forming material under vacuum and a suitable element for re-deoxidation to improve slag conditions and reduce the oxygen value
xi. Deoxidation and addition of alloying elements,
xii. Sending the liquid steel to the continuous casting machine to turn it into a semi-finished product through target analysis verification.

2. A production method according to claim 1, wherein the scrap to be melted contains various scrap types such as domestic, DKP, USA HMS, European HMS, Black Sea HMS, Package HMS, Pig, HBI, Busheling, Package Busheling, chopped, chopped low copper.

3. The production method according to claim 1, wherein the scrap used contains 30 to 100% of a scrap mixture, 0 to 70% of Pig Iron-HBI mixture by weight.

4. The production method according to claim 3, wherein the scrap used contains 50 to 100% of a scrap mixture, 0 to 50% of Pig Iron-HBI mixture by weight.

5. The production method according to claim 2, wherein the scrap used includes DKP, Pig, HBI, Busheling, Package Busheling scrap types.

6. The production method according to claim 5, wherein the scrap to be melted is 5 to 40% DKP, 15 to 35% Pig, 0 to 50% HBI, 5 to 50% Busheling, 1 to 40% Package Busheling by weight.

7. The production method according to claim 6, wherein the scrap to be melted is 10 to 35% by weight DKP, 20 to 30% Pig, 20 to 30% HBI, 15 to 40% Busheling, 2 to 35% Package Busheling.

8. The production method according to claim 2, wherein the scrap to be melted contains 10 to 35% DKP, 20 to 30% Pig, 15 to 40% Busheling, 2 to 35% Package Busheling, 2 to 35% by weight.

9. The method according to claim 1, wherein the appropriate element in the steps (iii) and (viii) where deoxidation processes are carried out is aluminum.

10. The method according to claim 1, wherein the liquid steel is kept in the following conditions before the step (iv):
A. Oxygen [O] ratio is less than 0.0005% by weight,
B. CaO/SiO₂ weight ratio is greater than 2.5 to ensure alkalinity of slag,
C. Inert gas mixing speed is 1000 Nl/min.

11. The method according to claim 1, wherein the alloying elements in step (v) are manganese (Mn), silicon (Si), aluminum (Al).

12. The method according to claim 1, wherein the denitrification process in step (vi) is done under pressure less than 1 mbar.

13. The method according to claim 1, wherein the volume of the inert gas mixed in the denitrification process in step (vi) is between 0.08 and 0.20 m³/Tons of Steel.

14. The method according to claim 1, wherein the oxygen blowing in step (vii) is to be carried out under a pressure of at least 8 bar and in a volume of 1 to 5 m3/Tons of steel.

15. The method according to claim 1, wherein the slag-forming material in the step (x) is lime, materials containing calcium oxide (CaO), materials containing aluminum oxide (Al₂O₃), materials containing silicon dioxide (SiO₂), aluminum slag and/or calcium fluorite (CaF₂).

16. Scrap for use in the production of interstitial free (IF) steel, comprising 30 to 100% by weight of the scrap mixture and 0 to 70% of Pig Iron-HBI mixture.

17. The scrap according to claim 16, comprising 50 to 100% by weight of the scrap mixture, 0 to 50% of Pig Iron-HBI mixture.

18. The scrap according to claim 16, comprising 5 to 40% DKP, 15 to 35% Pig, 0 to 50% HBI, 5 to 50% Busheling, 1 to 40% Package Busheling by weight.

19. The scrap according to claim 16, comprising 10 to 35% DKP, 20 to 30% Pig, 15 to 40% Busheling, 2 to 35% Package Busheling by weight.

20. The scrap according to claim 16, comprising 10 to 35% DKP, 20 to 30% Pig, 20 to 30% HBI, 15 to 40% Busheling, 2 to 35% Package Busheling by weight.

21. A high-quality IF steel, comprising a maximum content of 0.0040% by weight of carbon (C), a maximum of 0.10% by weight of manganese (Mn), a maximum of 0.03% by weight of silicon (Si), a maximum of % 0.0050, by weight of phosphorus (P), maximum % 0.0030 by weight sulfur, maximum % 0.040-0.060 by weight aluminum (Al), nitrogen (N) maximum 0.0040% by weight, maximum 0% oxygen (O) by weight 0002, the ratio of titanium (Ti) by weight in the range of 0.060-0.080%, the ratio of copper (Cu) by weight maximum of 0.06%.

22. An IF steel comprising 0.0040% of carbon (C) by weight maximum, 0.10% of manganese (Mn) by weight maximum, 0.03% of silicon (Si) by weight maximum, 0.0050% of phosphorus (P) by weight maximum, 0.0030% of sulfur by weight maximum, 0.040% to 0.060% of aluminum (Al) by weight, 0.0040% of nitrogen (N) by weight maximum, maximum 0.0002% of oxygen (O) by weight maximum, % 0.060 to 0.080 of titanium (Ti) by weight, 0.06% of copper (Cu) by weight and is produced by a method according to claim 1.

23. The IF steel according to claim 22, used in the automotive, white goods, and electronic goods sectors.
